(19) United States
(12) Patent Application Publication
(10) Pub. No.: US 2026/0051008 A1
(43) Pub. Date: Feb. 19, 2026

(54) SYSTEM AND METHOD FOR PERSONALIZED COACHING RECOMMENDATION

(71) Applicant: NICE LTD., Ra'anana (IL)

(72) Inventors: Shay DINER, Holon (IL); Or GERSHON, Petah Tikva (IL); Gennadi LEMBERSKY, Haifa (IL)

(21) Appl. No.: 18/807,984

(22) Filed: Aug. 18, 2024

(51) Int. Cl. G06Q 50/20; G06Q 10/0631

(52) U.S. Cl. CPC G06Q 50/205; G06Q 10/063112

(57) ABSTRACT

A computerized-method for determining an agent personalized coaching. The computerized-method includes for each agent in an agents database: (i) retrieving by one or more processors historical data. The historical data includes at least one of: a) past feedback; b) KPIs; and c) coaching training sessions; (ii) cleaning and structuring the historical data by operating by the one or more processors a data processor; (iii) assessing a level of impact of a plurality of coaching-plans based on the structured historical data to predict an effective-score for each coaching-plan in the plurality of coaching-plans on the KPIs by operating a CATE estimator on the coaching-plan; (iv) normalizing the effective-score of each coaching-plan and storing the normalized effective-score of each coaching-plan in a data-storage; (v) automatically selecting the personalized coaching-plan by operating a recommendation model on effective-scores in the data-storage; and (vi) automatically scheduling the personalized coaching plan for the agent.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis and more specifically, to determining an agent personalized coaching plan by a Conditional Average Treatment Effect (CATE) estimator and employing meta-learner models to optimize output-predictions of base learner models.

### BACKGROUND

Current coaching models lack personalization, and they are struggling to adapt to individual learning styles and goals. Furthermore, the existing methods fail to dynamically adjust to users' evolving needs and lack reliable metrics to measure the effectiveness of coaching interventions, leading to decreased user engagement and ineffective personal development.

Accordingly, there is a need for system and method for determining an agent personalized coaching.

### SUMMARY

There is thus provided, in accordance with some embodiments of the present disclosure, a computerized-method for determining an agent personalized coaching.

Furthermore, in accordance with some embodiments of the present disclosure, the computerized-method may include for each agent in an agent database: (i) retrieving by one or more processors historical data. The historical data includes at least one of: a) past feedback; b) Key performance Information (KPI)s; and c) coaching training sessions; (ii) cleaning and structuring the historical data by operating by the one or more processors a data processor; (iii) assessing a level of impact of a plurality of coaching-plans based on the structured historical data to predict an effective-score for each coaching-plan in the plurality of coaching-plans on the KPIs by operating a Conditional Average Treatment Effect (CATE) estimator on the coaching-plan; (iv) normalizing the effective-score of each coaching-plan and storing the normalized effective-score of each coaching-plan in a data-storage; (v) automatically selecting the personalized coaching-plan by operating a recommendation model on effective-scores in the data-storage; and (vi) automatically scheduling the personalized coaching plan for the agent.

Furthermore, in accordance with some embodiments of the present disclosure, the CATE estimator may be employing meta-learner models to optimize output-predictions of base learner models of the CATE estimator, and the meta-learner models may optimize the output-predictions by adjusting the output-predictions based on aggregated learning process across multiple agents and related coaching plans.

Furthermore, in accordance with some embodiments of the present disclosure, the meta-learners models may be at least one of: (i) S-learner model; (ii) T-learner model; (iii) X-learner model; and (iv) R-learner model. The S-learner model may be a model that applies a single mode across all data points to predict a KPI change. The T-learner model may be a model that uses two separate models for treated and control groups of agents to enhance accuracy of the predicted effective-score of the coaching plan, and the X-learner model is a model that improves estimates of the CATE estimator.

Furthermore, in accordance with some embodiments of the present disclosure, the recommendation model may include evaluating each normalized effective-score of each coaching-plan in a data-storage and selecting the personalized coaching-plan having the effective-score above a preconfigured threshold.

Furthermore, in accordance with some embodiments of the present disclosure, the selected personalized coaching-plan may include one or more coaching-plans.

Furthermore, in accordance with some embodiments of the present disclosure, the S-learner model may be trained by providing a single model x_i, t to predict Y(t),
whereby x_i is agent properties of past feedback and KPIs, and t indicates if the agent is treated and participated in the coaching plan,
when t=0 then the agent is in control group of agents, and
when t=1 then the agent participated in the coaching plan, and
Y(t) is the KPI change.

Furthermore, in accordance with some embodiments of the present disclosure, the single model may be Extreme Gradient Boosting (XGBoost) model.

Furthermore, in accordance with some embodiments of the present disclosure, the T-learner model may be trained by training a first model in the two separate models to predict the change in KPI after the agent participated in the coaching plan and a second model in the two separate models to predict the change in KPI when the agent didn't participate in the coaching plan.

### BRIEF DESCRIPTION OF THE DRAWINGS

FIGS. 1A-1B schematically illustrate a high-level diagram of a system for determining an agent personalized coaching, in accordance with some embodiments of the present disclosure;

FIGS. 2A-2B are a high-level workflow of a computerized-method for determining an agent personalized coaching, in accordance with some embodiments of the present disclosure;

FIG. 3 schematically illustrates segmentation structures, in accordance with some embodiments of the present disclosure;

FIG. 4 schematically illustrates control segments, in accordance with some embodiments of the present disclosure;

FIG. 5 schematically illustrates coaching segments and segments division based on dated of coaching sessions, in accordance with some embodiments of the present disclosure;

FIG. 6 schematically illustrates handling overlap in coaching sessions, in accordance with some embodiments of the present disclosure;

FIG. 7 presents a table showing aggregation of daily values into a weekly average for each metric, in accordance with some embodiments of the present disclosure;

FIG. 8 schematically illustrates an evaluation process using synthetic control, in accordance with some embodiments of the present disclosure;

FIG. 9 presents a table showing experiment results, in accordance with some embodiments of the present disclosure;

FIG. 10 schematically illustrates a dynamic recommendation generation, in accordance with some embodiments of the present disclosure;

FIG. 11 is a screenshot of a User Interface (UI) for personalized coaching, in accordance with some embodiments of the present disclosure; and

FIG. 12 is a screenshot of a UI for personalized coaching recommendation, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

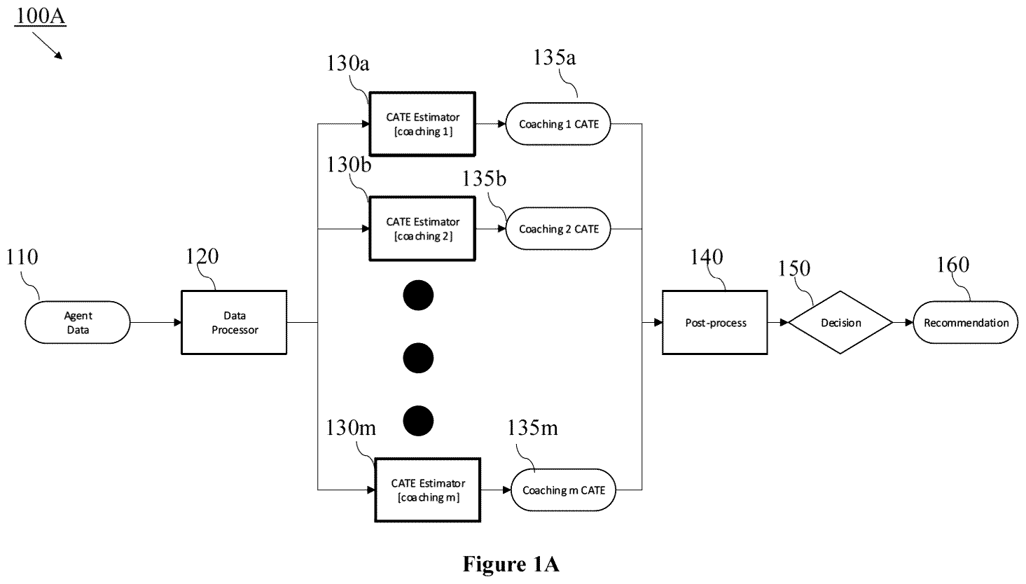

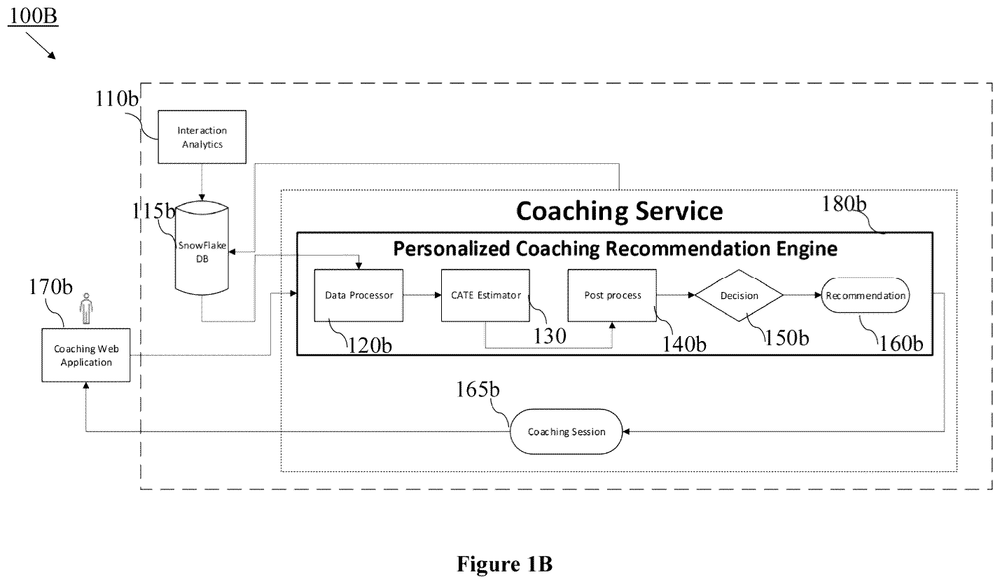

FIG. 1A schematically illustrates a high-level diagram of a system 100A for determining an agent personalized coaching, in accordance with some embodiments of the present disclosure.

According to some embodiments of the present disclosure, a computerized system, such as system 100A may be designed to optimize coaching interventions by using a structured, data-driven approach.

According to some embodiments of the present disclosure, system 100A may integrate Continuous Average Treatment Effect (CATE) estimators 130a-130m with a coaching platform to provide real-time, personalized coaching recommendations 160. This integration may apply a method commonly used in medical and economic research to the field of personal development and coaching. The CATE estimators 130a-130m may be used to evaluate the effect of an intervention, e.g., a coaching session, considering varying covariates that represent individual differences among users. Thus, allowing the system 100A to predict the most effective coaching strategies for each agent based on their specific characteristics and previous responses to interventions, e.g., coaching plans.

According to some embodiments of the present disclosure, system 100A may use the meta-learners to refine these predictions. Meta-learners analyze the outputs of multiple base learning models to improve the accuracy of the predictions. They are particularly adept at handling complexities that arise from the diverse data of different users, making the coaching recommendations not only personalized but also significantly more precise.

According to some embodiments of the present disclosure, system 100A may be seamlessly integrated across various industries and system sizes.

According to some embodiments of the present disclosure, agent data 110 may be collected for each agent in an agents database (not shown). The collected agent data may include historical data of the agent such as, past feedback, Key Performance Information (KPI)s and coaching training sessions related data. The agent data may be retrieved by one or more processors.

According to some embodiments of the present disclosure, the past feedback may include qualitative and quantitative feedback from supervisors, peers, and customers about the agent's performance, behavior, and skills. The KPIs may include measurable values that indicate how effectively the agent is achieving key business objectives. For example, efficiency, revenue per resolution, time spent in after-call work, overall experience quality scores, percentage of time signed in, and trust metrics. The coaching training sessions related data may include structured sessions aimed at improving specific skills or knowledge areas of the agent, including details of the training content, duration, objectives, and outcomes.

According to some embodiments of the present disclosure, the KPIs may be used to evaluate and score the effectiveness of different coaching plans on agent performance metrics using a statistical method.

According to some embodiments of the present disclosure, for example, the statistical method may be Continuous Average Treatment Effect (CATE) estimator. This method evaluates the effect of an intervention e.g., coaching session on a KPI by considering various covariates that represent individual differences among users. This approach is commonly applied in medical and economic research to provide a personalized estimate of the treatment's effect.

According to some embodiments of the present disclosure, a data processor 120 may be operated by the one or more processors to clean and structure the historical data of the agent. The cleaning and structuring may be operated to ensure that it is formatted and ready for analysis. It may include normalizing data types and handling missing values for better processing efficiency.

According to some embodiments of the present disclosure, the agent data may be provided as input to the data processor 120, such as a matrix containing numeric performance metrics. The data processor 120 may provide refined and structured agent data.

According to some embodiments of the present disclosure, the matrix may contain numeric performance metrics, e.g., KPIs, devoid of error values, e.g., Not a Number (NAN) values. The data may also be normalized, using either a model-specific or a general normalizer.

According to some embodiments of the present disclosure, various transformation methods may be applied, such as the sigmoid function:

$$S ( x ) = \frac{1}{1 + {e}^{x}}$$

Whereby x is the input agent data and e is the exponential function.

According to some embodiments of the present disclosure, each CATE estimator 130a-130m may receive refined and structured agent data, and a KPI. Each CATE estimator may provide a conditional average coaching effect of a coaching plan for a single KPI with a float number value. The CATE estimator may integrate meta-learners to refine the predictions of the CATE estimator. The single KPI refers to one of the key performance indicators used to measure an agent's performance. Examples of KPIs include efficiency, revenue per resolution, time spent in after-call work, overall experience quality scores, percentage of time signed in, and trust metrics.

According to some embodiments of the present disclosure, base learners refer to individual models within an ensemble learning framework. These models independently predict outcomes based on input data. The ensemble method, using meta-learners, combines these predictions to enhance accuracy and provide a more robust and precise personalized coaching recommendation.

According to some embodiments of the present disclosure, these meta-learner models optimize the output of base learners by adjusting predictions based on aggregated learning across multiple users and sessions. By examining this historical context of the agent, the system 100A develops a baseline understanding of each agent's requirements and progress patterns.

According to some embodiments of the present disclosure, each CATE estimator 130a-130m may employ meta-learner models to optimize output-predictions of base learner models of the CATE estimator. The meta-learner models may optimize the output-predictions by adjusting the output-predictions based on aggregated learning process across multiple agents and related coaching plans.

According to some embodiments of the present disclosure, system 100A may use the following meta-learners models: S-Learner model which may apply a single model across all data points to predict outcomes uniformly, T-Learner model which may use separate models for treated and control groups to enhance the accuracy of impact predictions and X-Learner model which may focus on improving estimates, particularly useful when one group e.g., control or treatment is significantly smaller than the other.

According to some embodiments of the present disclosure, the S-learner model applies a single model across all data points to predict outcomes uniformly. The S-learner model may train a single model, such as XGBoost that receives x_i, i.e., agent properties and t control or coaching and learns to predict Y(t), which is the KPI change. To assess CATE, the S-Learner model may run twice for treatment indicator set to off by t=0 and the treatment indicator set to on by t=1.

According to some embodiments of the present disclosure, the base-learner model may provide a prediction for feature x and treatment t μ(x,t)=E[Y|X=x,T=t] and the CATE estimator may provide the prediction for feature x when t=0 which means that the treatment indicator is off and there was no coaching and when t=1 which means that the treatment indicator is on. The difference between these two predictions gives the estimated treatment effect for each individual agent

$$τ ( x ) = μ ( x , 1 ) - μ ( x , 0 )$$

According to some embodiments of the present disclosure, the S-learner model may be trained using a single model that incorporates all data points, treating the presence of coaching, e.g., treatment, as a feature. The S-learner model uses agent properties and whether the agent was in the control or treatment group, as inputs.

According to some embodiments of the present disclosure, the S-learner model may be used to predict the potential change in KPIs (Y(t)) based on the input features. For prediction, the S-learner model may run with and without the treatment feature, e.g., t=0, t=1, to estimate the CATE, which is the difference in predicted KPIs due to the coaching.

According to some embodiments of the present disclosure, the XGBoost algorithm may be utilized for training the S-learner model, which incorporates agent properties and the treatment indicator to predict KPI changes.

According to some embodiments of the present disclosure, the S-learner model is trained by providing a single model x_i, t to predict Y(t),
whereby x_i is agent properties of past feedback and KPIs, and t indicates if the agent is treated and participated in the coaching plan,
when t=0 then the agent is in control group of agents and
when t=1 then the agent participated in the coaching plan, and
Y(t) is the KPI change.

According to some embodiments of the present disclosure, the single model may be Extreme Gradient Boosting (XGBoost) model.

According to some embodiments of the present disclosure, the T-learner may use separate models for treated and control groups, e.g., coaching and no coaching, to enhance the accuracy of impact predictions. Two models may be trained, one model may predict KPI change given treatment i.e., coaching, and the second model may predict the KPI change without coaching given.

$$\begin{matrix}μ\_ 0 ( x , t ) = E [ Y ( 0 ) \vert X = x ] \\ μ\_ 1 ( x , t ) = E [ Y ( 1 ) \vert X = x ] \\ The base - learners : μ\_ 0 ( x ) , μ\_ 1 ( x ) \\ The CATE : τ ( x ) = μ\_ 1 ( x ) - μ\_ 0 ( x )\end{matrix}$$

According to some embodiments of the present disclosure, the T-learner model may be trained by developing the two separate models. One model for the treatment group and another model for the control group. Each model may be trained on data from their respective groups only, focusing on predicting. Both models may predict KPI outcomes based on the properties of agents in their groups. The difference between the predicted KPIs from the treatment model and the control model may provide the CATE, an indication of the effect of the coaching.

According to some embodiments of the present disclosure, the T-learner model may be trained by training a first model in the two separate models to predict the change in KPI after the agent participated in the coaching plan and a second model in the two separate models to predict the change in KPI when the agent didn't participate in the coaching plan.

According to some embodiments of the present disclosure, the post-processing component 140 may refine the CATE outputs to ensure comparability, possibly through normalization using either a model-specific or a general normalizer. Various transformation methods may be applied, such as the sigmoid function:

$$S ( x ) = 1 / ( 1 + e \hat{} ( CATE\_i ) )$$

Where CATE_i is the coaching i CATE and e is the exponential function.

According to some embodiments of the present disclosure, using the insights derived from CATE estimators, the decision-making component evaluates potential coaching strategies. This process may involve Artificial Intelligence (AI) algorithms, statistical analysis, or Machine Learning (ML) models to select the optimal coaching actions.

According to some embodiments of the present disclosure, utilizing the insights derived from multiple CATE estimators, the decision-making component 150 may evaluate potential coaching strategies. The decision-making component 150 may receive an array or a vector of m CATE values, each associated with a coaching strategy 135a-135m to select a coaching strategy by a recommendation model 160. The recommendation model may evaluate each normalized effective-score of each coaching-plan in a data-storage and then may select the personalized coaching-plan having the effective-score above a preconfigured threshold.

According to some embodiments of the present disclosure, for example, each coaching strategy may be associated with a CATE value 135a-135m that quantifies its expected impact on an agent's performance. To decide which coaching strategy to apply, a threshold-based decision algorithm may be employed. A performance improvement threshold may be set based on organizational goals. For example, any coaching strategy that is predicted to improve performance by at least 5% may be considered effective. The CATE values of all m CATE 135a-135m may be compared to the performance improvement threshold. When multiple coaching strategies exceed the threshold, the one with the highest CATE value may be selected.

According to some embodiments of the present disclosure, when no coaching strategy exceeds the threshold, the agent may either not be selected any coaching or be reassigned to a less intensive intervention based on additional criteria.

According to some embodiments of the present disclosure, this threshold approach helps streamline the decision-making process by systematically selecting the most effective coaching strategy that aligns with predefined performance enhancement goals. The coaching actions in the selected coaching plan or strategy may be tailored to individual agent needs and may be available in various formats, such as single coaching sessions or a coaching mix, which combines multiple coaching treatments.

According to some embodiments of the present disclosure, unlike existing coaching methods that apply generic strategies, system 100A may utilize data-driven personalization. It may dynamically adapt coaching strategies based on individual user data, leveraging advanced predictive analytics to tailor each coaching session to the user's specific developmental needs and learning preferences. This ensures that coaching is always relevant and effective.

According to some embodiments of the present disclosure, the recommendation engine 160 may automatically select a personalized coaching plan, and then the selected personalized coaching plan may be automatically scheduled to the agent.

FIG. 1B schematically illustrates a high-level diagram of a system 100B for determining an agent personalized coaching, in accordance with some embodiments of the present disclosure.

According to some embodiments of the present disclosure, system 100B may include the same components as system 100A in FIG. 1A.

According to some embodiments of the present disclosure, the process may begin with the aggregation of data in Snowflake DB 115b, followed by sequential processing through the data processor 120b, CATE estimator 130, and post-process 140b components. Decision-making 150b is handled based on the analysis of CATE outputs, leading to the generation of personalized coaching recommendations 160b.

According to some embodiments of the present disclosure, the agents may be uniquely identified by an identifier, and their performance data may be stored in dictionaries or DataFrame structures, Universal Unique Identifier (UUID). The Key Performance Indicators (KPIs) may include efficiency, revenue per resolution, time spent in after-call work, overall experience, quality scores, percentage of time signed in, and trust metrics as a float numeric number.

According to some embodiments of the present disclosure, a personalized coaching recommendation engine 180b which may include a data processor 120b, such as data processor 120 in FIG. 1A, CATE estimator, such as CATE estimator 130a-130m in FIG. 1A, post process 140b, such as post process 140 in FIG. 1A, decision 150b, such as decision 150 in FIG. 1A and recommendation 160b, such as recommendation 160 in FIG. 1A, may employ algorithms to craft personalized coaching plans. These coaching plans are not one-size-fits-all but instead coaching plans which are tailored to align closely with each user's developmental trajectory and goals. This may ensure that each coaching session is relevant and effectively contributes to the agent's personal and professional growth.

According to some embodiments of the present disclosure, system 100B may be designed to evolve along with the agent. As agent's skills and needs change, the system 100B may detect these developments and may modify coaching plan recommendations accordingly. This adaptability may prevent the stagnation that often plagues traditional coaching methods.

According to some embodiments of the present disclosure, the integration of CATE estimators 130 allows for assessment of each coaching interaction's impact. This measurement is crucial for quantifying the effectiveness of the coaching sessions and for making informed adjustments to improve future recommendations.

According to some embodiments of the present disclosure, the meta-learners may be utilized to refine the predictions made by base learning models within the system. These meta-learners may analyze the outputs from multiple models and optimize the final coaching recommendations, ensuring they are highly personalized and effective.

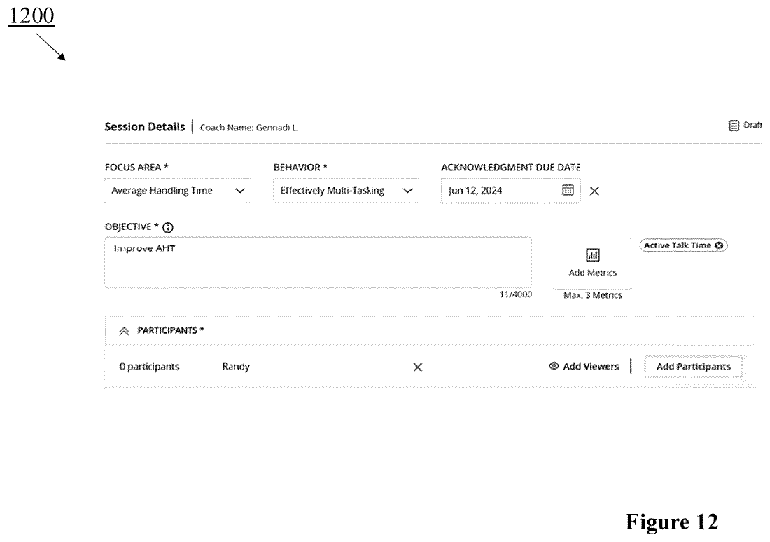

According to some embodiments of the present disclosure, based on the output from the predictive models and meta-learners, the system 100B may autonomously generate personalized coaching recommendations. These recommendations may be then presented to the user through a User Interface (UI), such as UI 1200 in FIG. 12, allowing for easy access and implementation.

According to some embodiments of the present disclosure, system 100B may address the lack of personalization and adaptability in existing coaching systems by using real-time data integration and advanced analytics, ensuring that each user receives effective, customized coaching that evolves with their needs.

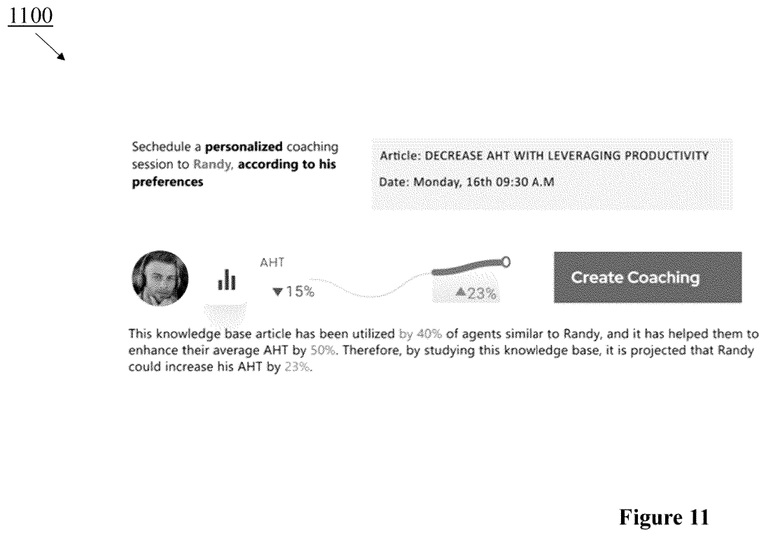

According to some embodiments of the present disclosure, coaching web application 170b, may be used to create and manage coaching sessions via a UI, such as UI 1100 in FIG. 11. Using the coaching web application 170b, a user may initiate the personalized coaching recommendation engine 180b and receive tailored coaching session recommendations for an agent. The user may enter the agent id as an input and run engine indication to receive a coaching session recommendation for an agent.

According to some embodiments of the present disclosure, the interaction analytics 110b may be provided with an interaction transcript of an agent to yield interactions KPIs which may be stored in a database or a cloud data platform that is processing, and analytics, such as snowflake DB 115b. The Snowflake DB 115b may receive historical data of the agent, such as performance metrics, feedback data and historical coaching interactions and may transfer the data to the data processor 120b for cleaning and structuring.

According to some embodiments of the present disclosure, the data processor 120b may perform cleansing and structuring of the incoming raw data to ensure it is formatted and primed for analysis and may yield refined and structured data which may be forwarded to the CATE estimator 130.

According to some embodiments of the present disclosure, the CATE estimator 130, such as CATE estimator 130a-130m in FIG. 1A, may apply multiple CATE estimators to the processed data to assess the potential impact of various coaching plans or strategies. The CATE estimator 130 may provide a value for each coaching plan.

According to some embodiments of the present disclosure, the post process component 140b may refine the CATE outputs to ensure comparability and readiness for decision-making. The post process 140b may receive CATE values from the CATE estimator 130 and may normalize the CATE values for decision making.

According to some embodiments of the present disclosure, the decision making 150b may evaluate the refined CATE values to select the most effective coaching strategies based on predefined performance enhancement goals. The decision-making component 150b may receive an array of normalized CATE values and may provide decision on the optimal coaching plan or strategy which may include multiple coaching plans.

According to some embodiments of the present disclosure, the recommendation component 160b may generate and automatically schedule the personalized coaching plan for the agent or optionally present the final coaching recommendations to the users based on the decision-making process. For example, UI 1200 in FIG. 12.

According to some embodiments of the present disclosure, coaching session 165b may include coaching and session related information.

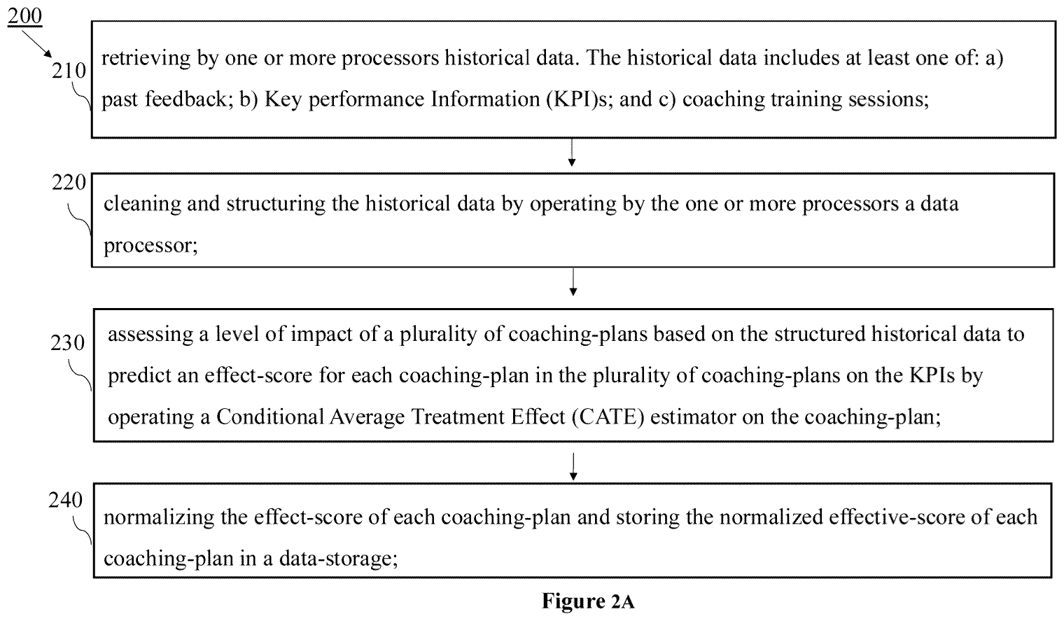

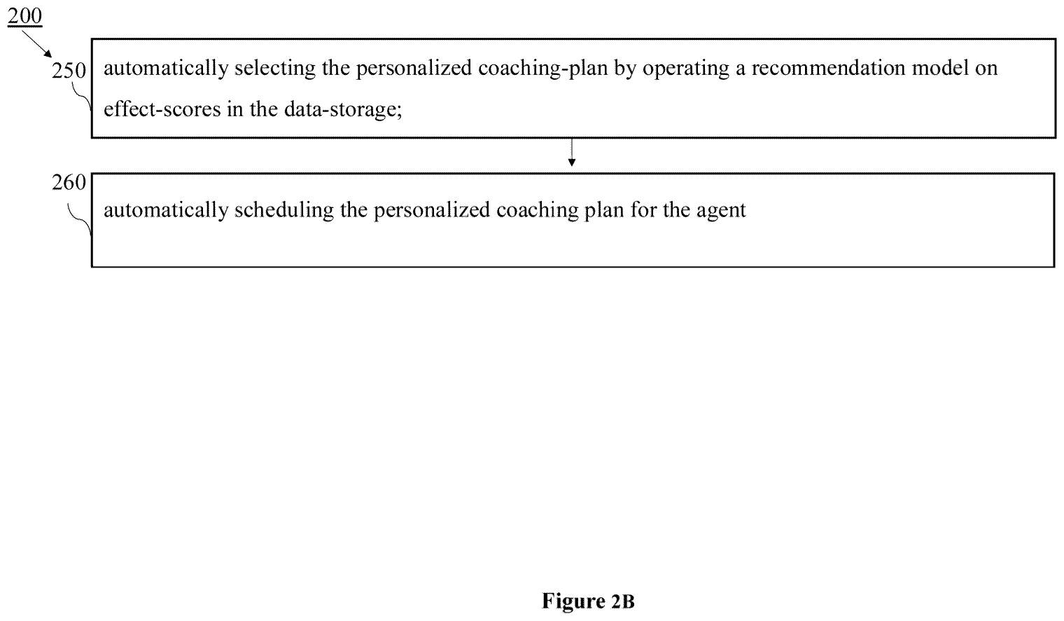

FIGS. 2A-2B are a high-level workflow of a computerized-method for determining an agent personalized coaching, in accordance with some embodiments of the present disclosure.

According to some embodiments of the present disclosure, operation 210 comprising retrieving by one or more processors historical data. The historical data includes at least one of: a) past feedback; b) Key performance Information (KPI)s; and c) coaching training sessions.

According to some embodiments of the present disclosure, operation 220 comprising cleaning and structuring the historical data by operating by the one or more processors a data processor.

According to some embodiments of the present disclosure, operation 230 comprising assessing a level of impact of a plurality of coaching-plans based on the structured historical data to predict an effective-score for each coaching-plan in the plurality of coaching-plans on the KPIs by operating a Conditional Average Treatment Effect (CATE) estimator on the coaching-plan.

According to some embodiments of the present disclosure, operation 240 comprising normalizing the effective-score of each coaching-plan and storing the normalized effective-score of each coaching-plan in a data-storage.

According to some embodiments of the present disclosure, operation 250 comprising automatically selecting the personalized coaching-plan by operating a recommendation model on effective-scores in the data-storage.

According to some embodiments of the present disclosure, operation 260 comprising automatically scheduling the personalized coaching plan for the agent.

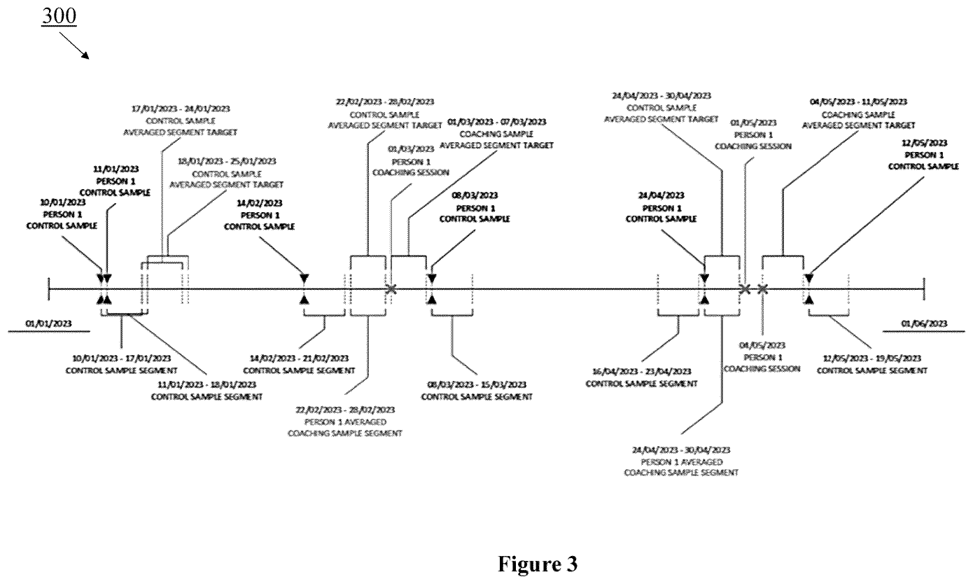

FIG. 3 schematically illustrates segmentation structures 300, in accordance with some embodiments of the present disclosure.

According to some embodiments of the present disclosure, the agent historic data may be divided into segments that reflect periods influenced by coaching interventions and control periods without such interventions.

According to some embodiments of the present disclosure, data preparation may include segmenting the dataset into two main categories: periods following a coaching session and control periods. Control periods may be identified as time frames where no coaching occurred. These periods serve as a baseline to compare and assess the impact of the coaching sessions.

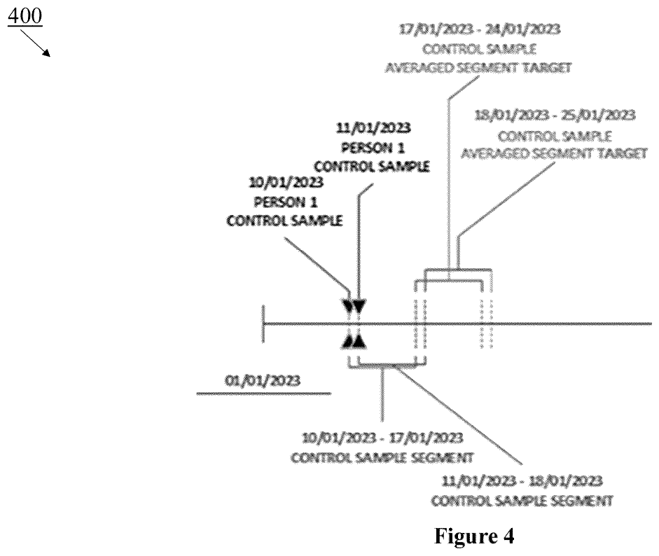

FIG. 4 schematically illustrates control segments, in accordance with some embodiments of the present disclosure.

According to some embodiments of the present disclosure, for each agent, the timeline may be divided based on the dates of coaching sessions. Each segment may capture the time frame from the date of a coaching session to a specified number of days after, defined as the ‘coaching effect days’.

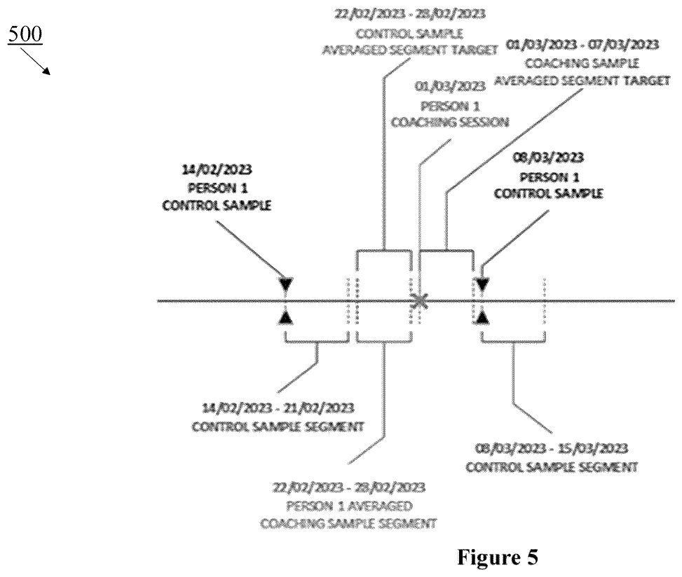

FIG. 5 schematically illustrates coaching segments and segments division based on dated of coaching sessions, in accordance with some embodiments of the present disclosure.

According to some embodiments of the present disclosure, for each agent, the timeline is divided based on the dates of coaching sessions. Each segment captures the time frame from the date of a coaching session to a specified number of days after, defined as the ‘coaching effect days’ an integer value such as, 7.

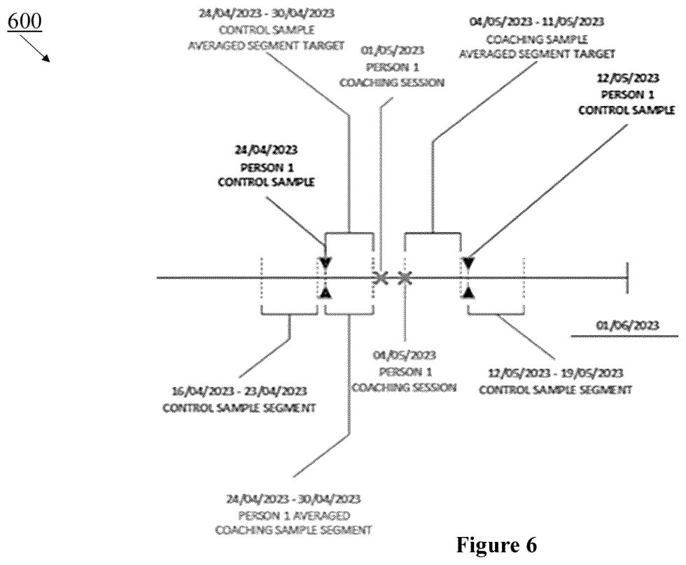

FIG. 6 schematically illustrates handling overlap in coaching sessions, in accordance with some embodiments of the present disclosure.

According to some embodiments of the present disclosure, when there is another coaching session during the defined ‘coaching effect days’, e.g., overlap in coaching sessions, it may be handled by system 100A in FIG. 1A and system 100B in FIG. 1B, by extending the aggregation time window to accommodate this overlap.

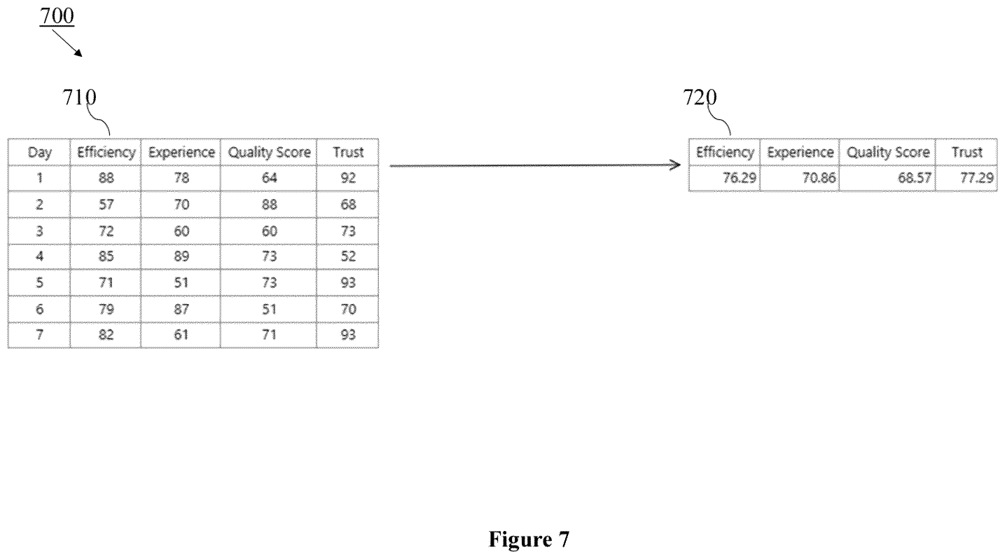

FIG. 7 presents a table showing aggregation of daily values into a weekly average for each metric, in accordance with some embodiments of the present disclosure.

According to some embodiments of the present disclosure, for both coaching and control segments, an aggregation operation may be performed in system 100A in FIG. 1A and system 100B in FIG. 1B to condense the daily metrics into a summarized format. Optionally, this operation may involve calculating the average values for each metric across the defined period, which allows for a consistent comparison between the effects of coaching interventions and no intervention over an agent.

According to some embodiments of the present disclosure, for example, the control segment may be defined as a 7-day period without any coaching interventions. For this segment, the data matrix might be structured as 7 days (rows)×4 features (columns), with features including ‘Efficiency’, ‘Experience’, ‘Quality Score’, and ‘Trust’. The aggregation operation calculates the average for each feature across the 7 days, resulting in a 1×4 matrix that encapsulates the average values of each feature during the control period.

According to some embodiments of the present disclosure, for a coaching segment, which also spans 7 days, the same aggregation operation is applied. The resulting 1×4 matrix for the coaching segment provides average values for each feature, reflecting the impact of the coaching sessions over this period.

According to some embodiments of the present disclosure, this aggregation process may be performed by the following steps for each segment. Collecting daily data for each feature within the segment. Then, structuring this data into a matrix format, with days as rows and features as columns. Computing the average of each feature across all days in the segment, resulting in a single row that represents the summarized performance or impact for the period.

According to some embodiments of the present disclosure, for example, when data is collected over a 7-day period for four key features: ‘Efficiency’, ‘Experience’, ‘Quality Score’, and ‘Trust’. The data matrix may be as shown in table 710 and the average values calculated may be as shown in table 720.

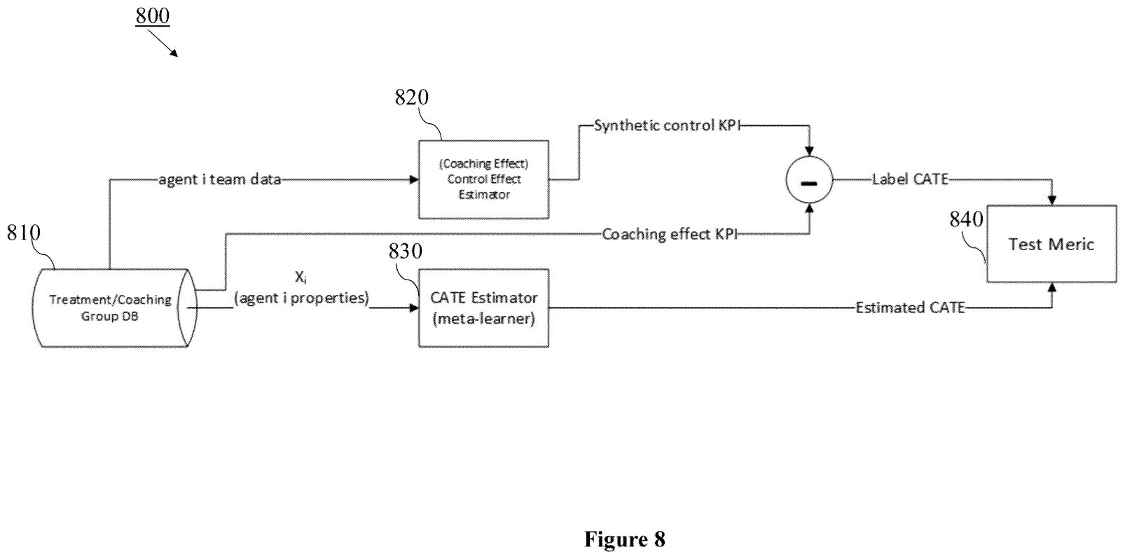

FIG. 8 schematically illustrates an evaluation process using synthetic control, in accordance with some embodiments of the present disclosure.

According to some embodiments of the present disclosure, system 100A in FIG. 1A and system 100B in FIG. 1B may employ inference models including S-Learner, T-Learner, X-Learner, and R-Learner, utilizing XGBoost as the base regressor. These models are tasked with estimating CATE, which represents the expected change in KPIs as a result of coaching interventions, e.g., selected coaching plan.

According to some embodiments of the present disclosure, for each type of causal inference model, separate models have been trained for a predefined KPIs, for example seven different KPIs, such as % After Call Work (ACW) time, efficiency, experience, quality score, revenue per resolution (Rev/Res), signed-in %, trust, resulting in a comprehensive analysis tailored to each specific performance indicator. Each KPI model helps in understanding the specific impacts of coaching on different aspects of agent performance.

According to some embodiments of the present disclosure, the Rev/Res is a KPI used to measure the revenue generated per resolved issue or ticket by an agent. This metric helps in assessing the financial efficiency and effectiveness of an agent's performance. Trust is a key performance indicator (KPI) that measures the level of trust clients or customers have in the agent's performance. This metric can be derived from customer feedback, satisfaction surveys, and other qualitative assessments, reflecting the agent's reliability and credibility.

According to some embodiments of the present disclosure, a logistic regression model may be used to estimate the propensity scores. Logistic regression is a statistical model that predicts the probability of a binary outcome, e.g., receiving coaching or not, based on one or more predictor variables e.g., agent properties. This method helps in adjusting for biases and providing a balanced comparison between treated and control groups. For example, the dataset may be split into a training set, such as 70% and the rest of it 30%, may be used as a testing set, where the models are trained to predict the CATE value for each KPI based on agent properties, which are scaled to ensure a standardized and fair comparison across different KPIs.

According to some embodiments of the present disclosure, propensity scores are used to estimate the probability of an agent receiving a particular treatment e.g., coaching, given their covariates, e.g., agent properties. These scores help in balancing the data and adjusting for potential biases, ensuring a more accurate assessment of the treatment effects. The propensity scores may be estimated using logistic regression models.

According to some embodiments of the present disclosure, the logistic regression model may be for example, a logistic regression model used to estimate the propensity score for an agent receiving coaching. The model might include covariates, such as agent experience, previous performance scores, and frequency of past coaching sessions. The logistic regression equation may be for example, logit(P(coaching))=β0+β1*experience+β2*previous_performance+β3*past_coaching whereby P(coaching) is the probability of the agent receiving coaching, and β0, β1, β2, and β3 are the coefficients estimated by the model.

According to some embodiments of the present disclosure, a Mean Squared Error (MSE) may measure the average of the squares of the errors, that is, the average squared difference between the estimated values and what is estimated. For each model and KPI combination, the average MSE may be calculated across all agents to assess the variance and predictive accuracy of the models consistently.

According to some embodiments of the present disclosure, a Mean Absolute Error (MAE) may be a measure of errors between paired observations expressing the same phenomenon. Similar to MSE, the average MAE may be calculated for each model and KPI combination across agents, providing a clear measure of the average error magnitude and allowing for an intuitive understanding of the error distribution in the predictions.

According to some embodiments of the present disclosure, the learner models may analyze agent characteristics to predict the Conditional Average Treatment Effect (CATE), which may indicate the potential impact of coaching on the change in agent's KPI. This impact may be determined by comparing the difference in KPIs for an agent who receives coaching versus one who does not. Specifically, it calculates the difference between the agent's KPI after coaching and the agent's KPI without coaching.

According to some embodiments of the present disclosure, the models, e.g., CATE estimators, aim to establish a quantitative link between coaching sessions and changes in KPIs, quantifying the effectiveness of these interventions.

According to some embodiments of the present disclosure, system 100A in FIG. 1A and system 100B in FIG. 1B may utilize a synthetic control group methodology to validate CATE estimators, ensuring robust assessments of coaching effectiveness based on detailed performance metrics of agents.

According to some embodiments of the present disclosure, a treatment/coaching group database 810 may be used as the central repository for storing and retrieving agent properties and their respective KPIs, which form the basis for both treated and control group comparisons. This database may include comprehensive data on each agent and their team, including KPIs in scenarios where coaching was provided and where it was not. This data is essential for creating a factual and counterfactual basis for analysis.

According to some embodiments of the present disclosure, the coaching effect, control effect estimator 820, may estimate the KPIs for an agent as predicted if the agent had not received any coaching, providing a baseline to compare the actual coaching effect. The coaching effect, control effect estimator 820 may receive KPIs and other relevant data from the agent's team, sourced from the treatment/coaching group database 810. The coaching effect, control effect estimator 820, may estimate the KPI for the agent, representing what would likely have been observed had the agent been in the control group.

According to some embodiments of the present disclosure, the coaching effect, control effect estimator 820, may use a regression model to predict the agent's KPIs in the absence of coaching. The coaching effect, control effect estimator 820 may process the agent's current KPIs against historical data of similar agents e.g., control group to estimate a counterfactual performance scenario.

According to some embodiments of the present disclosure, the regression model may be defined as:

$$Y\_ ( Synthetic KPI ) \hat{} ( ( Agent ) ) = β\_ 0 + β\_ 1 KPI \_ 1 + β\_ 2 KPI \_ 2 + … + β\_n KPI \_n$$

Y_(Synthetic KPI)\hat{ }(i) is the agent i synthetic control KPI. [symbol]
KPI [symbol] _1, [symbol] KPI [symbol] _2, . . . , [symbol] KPI [symbol] _n are the agent team members KPIs.
β_0, β_1, . . . , β_n are the coefficients that weigh the importance of each KPI in predicting the outcome.

According to some embodiments of the present disclosure, the synthetic control KPIs may be used to establish a baseline for comparison, representing what the agent's performance metrics might have looked like without the intervention, e.g., coaching session, a synthetic agent from a pool of agents who did not receive coaching may be constructed.

According to some embodiments of the present disclosure, the CATE estimator 830, such as CATE estimator 130a-130m in FIG. 1A, may calculate label CATE to determine the estimated impact of the coaching on agent's performance by calculating the difference between the observed KPIs during coaching and the estimated control KPIs i.e., synthetic control KPIs.

According to some embodiments of the present disclosure, the CATE estimator 830 may receive actual KPIs observed during coaching and the estimated control KPIs and may provide label CATE which may quantify the coaching effect, Y(t). The CATE estimator 830 may subtract the estimated control KPIs from the actual observed KPIs to derive the label CATE.

According to some embodiments of the present disclosure, the CATE estimator 830 compare the CATE values to evaluate the accuracy and effectiveness of the CATE estimators by comparing the label CATE with the estimated CATE. The comparison may be a direct comparison of the label CATE derived from actual and estimated data against the estimated CATE provided by the meta-learner, assessing how closely the estimations match the observed outcomes.

According to some embodiments of the present disclosure, the evaluation may focus exclusively on data from coaching periods, using synthetic controls as a benchmark to assess the real impact of coaching. This approach isolates the effect of coaching by comparing the predicted CATE, e.g., estimated impact Y(t) of the coaching plan on a KPI with the synthetic CATE, e.g., observed impact, providing a robust assessment of the models' precision and the actual effectiveness of coaching interventions.

According to some embodiments of the present disclosure, the purpose of the evaluation process using synthetic control 800 is to evaluate the effectiveness of the predicted Conditional Average Treatment Effect (CATE) estimator. The challenge lies in the absence of the false/Label CATE, as there is only KPI Y(t=1), which represents the KPI of an agent after receiving coaching. Having the false/Lable CATE Y(t=0), the KPI after not receiving coaching, would allow a direct calculation of the real CATE by subtracting Y(t=0) from Y(t=1). To address the absence of the false/Label CATE, a model named Control Effect Estimator (820), which predicts Y(t=0) may be trained. [LL—I've changed it from absence of true to absence of false label—please confirm]

According to some embodiments of the present disclosure, this prediction of the KPI Y(t=0) of the agent may allow an approximate calculation of the actual/Label CATE, which is the change in KPI due to training. Then, a comparison of this approximate Label CATE with the Estimated CATE may be operated and if the values are close, it indicates of a good performance of the CATE Estimator. The Test Metric (840) used for this evaluation is the Mean Squared Error (MSE), which quantifies the difference between the Label CATE and the Estimated CATE.

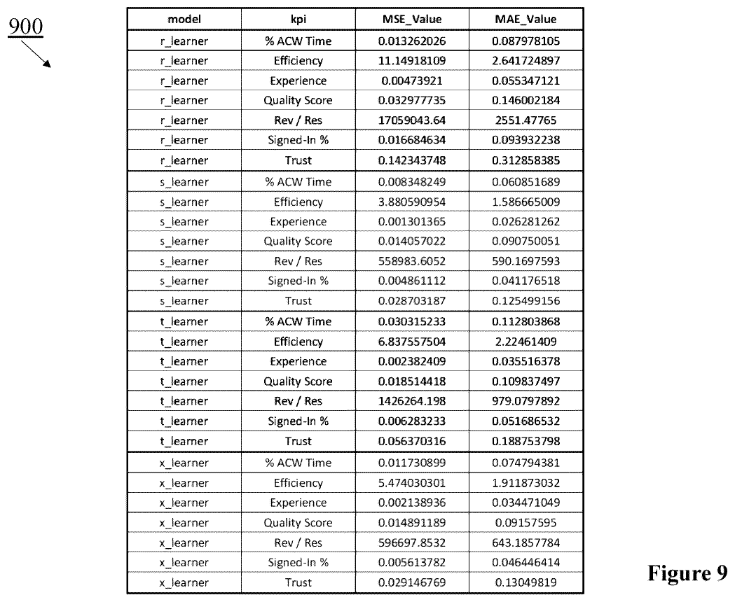

FIG. 9 presents a table 900 showing experiment results, in accordance with some embodiments of the present disclosure.

According to some embodiments of the present disclosure, the results show that R-learner exhibits high variability in performance across KPIs. Particularly high MSE and MAE values in ‘Rev/Res’ e.g., 17,059,043.64 and 2551.47 respectively, suggest significant errors in predictions for revenue or resolution-based metrics. Performs moderately well on ‘Trust’ and ‘% ACW Time’ with relatively lower MSE and MAE values, indicating better accuracy in predicting trust-related metrics and after-call work time.

According to some embodiments of the present disclosure, the results show that the S-learner has achieved generally lower MSE and MAE values across most KPIs compared to the R-learner, indicating a more consistent performance. Notably performs best among all learners in ‘Rev/Res’ with significantly lower MSE and MAE values e.g., 558,983.61 and 590.17 respectively. Excellent performance in predicting ‘% ACW Time’ and ‘signed-in %’ with the lowest errors, which suggests it handles operational and engagement KPIs effectively.

According to some embodiments of the present disclosure, the results show that the T-learner reflects mixed results; it has high errors in ‘Efficiency’ and ‘Rev/Res’ but manages better performance in ‘Experience’ and ‘Quality Score’. The high MSE in ‘Rev/Res’ (1,426,264.20) and ‘Efficiency’ (6.84) may indicate challenges in models dealing with complex or highly variable KPIs.

According to some embodiments of the present disclosure, the results show that the X-learner provides a balanced performance across the board with no extreme highs or lows in error metrics. This suggests a well-rounded capability in handling various KPI types. The X-learner's performance in ‘Efficiency’ and ‘Rev/Res’ is better than the T-learner model, but not as good as the S-learner, positioning it as a middle ground in terms of prediction accuracy.

According to some embodiments of the present disclosure, the best overall performance is of the S-learner which demonstrates the lowest MSE and MAE across multiple important metrics, suggesting it is the most reliable for consistent performance across varied KPIs. The challenges in High Variance KPIs may be that the R-learner and T-learner struggle with KPIs that likely have higher variability such as ‘Rev/Res’ and ‘Efficiency’. This might be due to these models not capturing all underlying patterns or being sensitive to outliers.

According to some embodiments of the present disclosure, all meta-learners perform relatively well on operational KPIs like ‘% ACW Time’ and ‘Signed-In %’, which might be due to these KPIs having more straightforward or less variable data patterns.

According to some embodiments of the present disclosure, the choice of the meta-learner might depend on the specific type of KPIs being targeted. While the S-learner appears to be the most robust for a broad range of applications, specific cases like high-value financial metrics might benefit from tailored approaches or further optimization of the existing models.

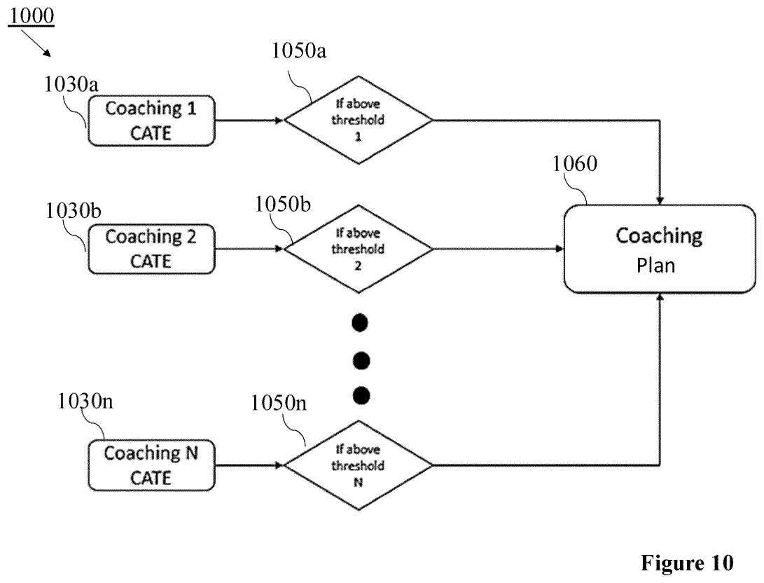

FIG. 10 schematically illustrates a dynamic recommendation generation, in accordance with some embodiments of the present disclosure.

According to some embodiments of the present disclosure, by using the calculated CATE values 1030a-1030n, the system, such as system 100A in FIG. 1A and such as system 100B in FIG. 1B, may generate coaching recommendations with no human intervention, ensuring immediate and relevant action items for the user.

According to some embodiments of the present disclosure, coaching 1<i<N CATE 1030a-1030n, may be the output of the CATE estimator component, such as CATE estimator 130a-130m in FIG. 1A. The system, such as system 100A in FIG. 1A and such as system 100B in FIG. 1B, may utilize the CATE values, which quantify the expected impact of various coaching interventions on specific KPIs, for each agent. These values may be derived from the predictive models.

According to some embodiments of the present disclosure, each CATE value may be assessed against a predefined threshold 1050a-1050n specific to the type of coaching plan or intervention. These thresholds may be established based on historical data and optimized to ensure they reflect meaningful improvements in performance metrics.

According to some embodiments of the present disclosure, for each type of coaching plan, e.g., Coaching 1, Coaching 2, . . . . Coaching N, the corresponding CATE value 1030a-1030n may be compared against its threshold 1050a-1050n. When the CATE value for a particular type of coaching exceeds its threshold, it may indicate that the coaching plan or intervention is likely to result in a significant improvement in the agent's performance. When a CATE value meets or exceeds the threshold, the system flags the corresponding coaching intervention as a recommended action.

According to some embodiments of the present disclosure, for example, the thresholds for the CATE values may be determined based on historical data and predefined performance improvement goals. In a non-limiting example, a threshold might be set to indicate a 5% improvement in a specific KPI. If a coaching plan's CATE value exceeds this threshold, it signifies that the plan is likely to lead to significant performance improvement. These thresholds may be configured based on organizational goals and are adjusted as more data becomes available to ensure they accurately reflect meaningful improvements.

According to some embodiments of the present disclosure, when multiple coaching plans exceed their respective thresholds for a single agent, these coaching plans may be combined into a mix of coaching plans. This mix approach ensures a comprehensive coaching strategy that addresses multiple areas of potential improvement simultaneously, thereby maximizing the efficiency and impact of the coaching process.

FIG. 11 is a screenshot of a User Interface (UI) 1100 for personalized coaching, in accordance with some embodiments of the present disclosure.

According to some embodiments of the present disclosure, UI 1100 is an example of a screenshot for personalized coaching recommendation for agent's performance. This UI demonstrates the activation of a system, such as system 100A in FIG. 1A and system 100B in FIG. 1B through the coaching web application, such as coaching web application 170b in FIG. 1B to address an identified performance issue in an agent named Randy.

According to some embodiments of the present disclosure, for example, when a user notices an issue, such as a 15% decline in Randy's Average Handling Time (AHT) KPI metric since last coaching session, the user may activate the recommendation engine to address this issue by clicking on the “Create Coaching” button.

According to some embodiments of the present disclosure, upon user click on the ‘create coaching’ button, a recommendation engine, such as system 100A in FIG. 1A and such as system 100B in FIG. 1B may be activated. The system may analyze Randy's performance data, e.g., historic data, and may identify coaching strategies, e.g., coaching plans, that most likely impact AHT positively and result in increase in the metric.

According to some embodiments of the present disclosure, each CATE value is compared against a predefined threshold specific to the type of coaching intervention. If a CATE value meets or exceeds the threshold, the system may recommend the corresponding coaching strategy. Using the calculated CATE values, the system may generate coaching recommendations without human intervention. The recommendations are then provided to the user, for example, as shown in UI 1200 in FIG. 12

FIG. 12 is a screenshot of a UI 1200 for personalized coaching recommendation, in accordance with some embodiments of the present disclosure.

According to some embodiments of the present disclosure, as shown in UI 1200 the coaching plan that is targeted in a KPI, such as AHT may be related to a behavior, such as effectively multi-tasking that may be the subject of the coaching plan to improve the KPI.

According to some embodiments of the present disclosure, in a system, such as system 100A in FIG. 1A and such as system 100B in FIG. 1B, the personalized coaching-plan may be selected by operating the recommendation model, e.g., recommendation engine, on effective-scores in the data-storage and then the personalized coaching plan may be automatically scheduled for the agent, e.g., participant Randy.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for determining an agent personalized coaching, said computerized-method comprising:
for each agent in an agents database:
(i) retrieving by one or more processors historical data,
wherein said historical data includes at least one of: a) past feedback; b) Key Performance Information (KPI)s; and c) coaching training sessions;
(ii) cleaning and structuring the historical data by operating by the one or more processors a data processor;
(iii) assessing a level of impact of a plurality of coaching-plans based on the structured historical data to predict an effective-score for each coaching-plan in the plurality of coaching-plans on the KPIs by operating a Conditional Average Treatment Effect (CATE) estimator on the coaching-plan;
(iv) normalizing the effective-score of each coaching-plan and storing the normalized effective-score of each coaching-plan in a data-storage;
(v) automatically selecting the personalized coaching-plan by operating a recommendation model on effective-scores in the data-storage; and
(vi) automatically scheduling the personalized coaching plan for the agent.

2. The computerized-method of claim 1, wherein said CATE estimator is employing meta-learner models to optimize output-predictions of base learner models of the CATE estimator, and wherein the meta-learner models optimize the output-predictions by adjusting the output-predictions based on aggregated learning process across multiple agents and related coaching plans.

3. The computerized-method of claim 2, wherein said meta-learners models are at least one of: (i) S-learner model; (ii) T-learner model; (iii) X-learner model; and (iv) R-learner model, wherein the S-learner model is a model that applies a single mode across all data points to predict a KPI change,
wherein the T-learner model is a model that uses two separate models for treated and control groups of agents to enhance accuracy of the predicted effective-score of the coaching plan, and
wherein the X-learner model is a model that improves estimates of the CATE estimator.

4. The computerized-method of claim 1, wherein said recommendation model comprising evaluating each normalized effective-score of each coaching-plan in a data-storage and selecting the personalized coaching-plan having the effective-score above a preconfigured threshold.

5. The computerized-method of claim 4, wherein the selected personalized coaching-plan comprising one or more coaching-plans.

6. The computerized-method of claim 3, wherein said S-learner model is trained by providing a single model xᵢ, t to predict Y(t),
whereby xᵢ is agent properties of past feedback and KPIs, and t indicates if the agent is treated and participated in the coaching plan,
wherein when t=0 then the agent is in control group of agents and wherein when t=1 then the agent participated in the coaching plan, and Y(t) is the KPI change.

7. The computerized-method of claim 6, wherein said single model is Extreme Gradient Boosting (XGBoost) model.

8. The computerized-method of claim 3, wherein said T-learner model is trained by training a first model in the two separate models to predict the change in KPI after the agent participated in the coaching plan and a second model in the two separate models to predict the change in KPI when the agent didn't participate in the coaching plan.
